(19) United States
(12) Patent Application Publication
(10) Pub. No.: US 2025/0115020 A1
(43) Pub. Date: Apr. 10, 2025

(54) MACHINE AND METHOD FOR PRODUCING DRINK STIRRING STICKS MADE OF PAPER MATERIAL

(71) Applicant: Stefano BIANUCCI, Lucca (IT)

(72) Inventor: Riccardo CENTONI, Lucca (IT)

(73) Assignee: Stefano BIANUCCI, Lucca (IT)

(21) Appl. No.: 18/293,758

(22) PCT Filed: Aug. 1, 2022
(86) PCT No.: PCT/IB2022/057109

§ 371 Date: Jan. 30, 2024

(30) Foreign Application Priority Data
Aug. 3, 2021 (IT) 102021000020903

(51) Int. Cl. B31D 5/00; B31D 5/04

(52) U.S. Cl. CPC B31D 5/0091; B31D 5/04

(57) ABSTRACT

A machine (1) for producing drink stirring sticks (105) made of paper material comprising a feeding device (10) for feeding a web or sheet made of paper material (100) along a predetermined feeding direction (110). The machine (1) comprises a separation unit (200) for separating a plurality of curved elongated portions (105) from the web or sheet. The separation unit (200) comprises a folding device (40) configured to fold the web or sheet in such a way to separate the curved elongated portions (105) from the web or sheet. The folding device (40) is equipped with a first folding member (41) provided with at least one protruding portion (43) and a second folding member (42) provided with at least one recessed portion (44) having a shape which is complementary to the or each protruding portion (43) and arranged to be positioned adjacent to respective sides (101,102) of said web or sheet to apply a folding action on said web or sheet at a folding zone (45).

### FIELD OF THE INVENTION

The present invention relates to the field of the machines for producing mass consumption products, in particular sticks for stirring drinks, such as coffee, tea, cappuccino, milk, and similar, in particular, but not exclusively of the type dispensed by drink vending machines. The invention also refers to a method for producing drink stirring sticks made of paper material.

### BACKGROUND OF THE INVENTION

As it is known, generally to stir the drinks such as coffee, tea, cappuccino, in particular to facilitate sugar, or any other sweetening substance, to be dissolved, but also to accelerate their cooling, in the case of hot drinks, the traditional spoon made of metal has been replaced almost anywhere by a stirrer made of plastic, i.e. a flat oblong element. In particular, the drink stirring sticks are provided to the user together with the drink almost in all the public places such as the cafe, the bar, the restaurants, etc. because besides providing significant safe running costs for the shopkeeper with respect to the traditional spoons made of metal, they avoid the need to collect them after their use and to wash them in a dishwasher. In addition to the above, the stirring sticks represent the ideal solution for drinking the take-away drinks both in public and private places, such as offices, companies, and recreational places in general.

Substantially for the same reasons the drink stirring sticks have had a wide diffusion also in the vending machines of drinks that are installed in public, or private places. In this case, the drink vending machines, in particular for coffee, tea, cappuccino, milk, and similar drinks, further to a device for supplying the drink, normally provide a dispenser for dispensing glasses made of plastic, or paper, and stirring sticks which are used by the user to stir the drink within the glass.

Recently, thanks to an increased general sensitivity towards the environmental problems, it has been attempted to produce stirring sticks made of wood, or made of paper material with a low environmental impact. Therefore, some lines for producing stirring sticks made of paper material, or wood, have been proposed.

However, the sticks made of paper material that are produced at the moment have many drawbacks.

In the first place, the present flat stirrers made of paper material, once that they have been introduced into the drink, tend to absorb the same and, therefore, to lose partly, or completely, their rigidity, making considerably more difficult to stir the drink by the user, up to compromising its organoleptic properties because “dissolving” some fragments of the stirrer can come off and pollute the drink making it practically undrinkable.

An example of a vending machine provided with a dispenser of flat stirrers made of disposable material having the aforementioned drawbacks is described in WO2020/225669. In this case, the stirrer dispenser dispenses the stirrers starting from a flat strip made of a disposable food material which is wound to form a roll. The stirrer dispenser provides to unwind the disposable material forming a flat strip that is cut by a blade once that a determined length is reached in order to obtain a flat stirrer, which is, then, dispensed by the vending machine.

A first drawback of the solution described in WO2020/225669 is the high size of the roll, which has to be positioned within the vending machine together with the devices that are provided to carry out the unwinding of the strip of material and its cut in order to obtain the stirrer.

A further drawback is that the blade is close to the catching zone where the user grabs the stick. This solution, in fact, is not able to assure the necessary safety conditions, because the user could stretch out his/her hand up to reaching the cutting blade and actuate the same, or touch its cutting profile and then endanger his/her safety. Furthermore, the unwinding and cutting devices described in WO2020/225669 do not seem to be efficient and able to produce a disposable stirring stick rigid enough to avoid that the same could deteriorate and sufficiently quickly to be compatible with the performances that are normally requested for a drink vending machine.

### SUMMARY OF THE INVENTION

It is, therefore, an object of the present invention to provide a machine for producing drink stirring sticks that is able to overcome the aforementioned drawbacks of the prior art machines.

It is, in particular, an object of the present invention to provide a machine for producing drink stirring sticks that is able to produce stirring sticks with a high rigidity and that are able to withstand to stresses such as those to which they are normally subjected during their use.

It is also an object of the present invention to provide a method for producing drink stirring sticks having analogous advantages.

These and other objects are achieved by a machine for producing drink stirring sticks made of paper material comprising:
a feeding device configured to feed a web or sheet made of paper material along a predetermined feeding direction;
   whose main characteristic is to provide, furthermore, a separation unit positioned along said predetermined feeding direction, and configured to separate a plurality of curved elongated portions from said web or sheet made of paper material;
   that said separation unit comprises:
a folding device configured to fold said web or sheet made of paper material in such a way to separate the aforementioned plurality of curved elongated portions from the web or sheet made of paper material;
at least one cutting member configured to cut the web or sheet made of paper material, said, or each, cutting member being configured to cut the web or sheet made of paper material and to obtain a plurality of cutting lines, for example weakening lines, or pre-cut lines, but also clean-cut lines, each of which perimetrically delimiting a respective elongated portion having a longitudinal axis;
   and that the aforementioned folding device is equipped with:
a first folding member provided with at least one protruding portion;
a second folding member provided with at least one recessed portion having a shape complementary to said, or each, protruding portion of said first folding member, said or each protruding portion and said or each recessed portion being arranged to be positioned adjacent to respective sides of said web or sheet made of paper material to apply a folding action on said web or sheet made of paper material at a folding zone.

Other features of the invention are described in the dependent claims which define particular embodiments of the present invention.

In particular, the separation unit can comprise, furthermore, a cutting device provided with said, or each, cutting member configured to cut the web or sheet made of paper material. More in particular, the or each cutting member can be configured to obtain a cut web or sheet made of paper material provided with a plurality of cutting lines, for example weakening lines, or pre-cut lines, or tear-off lines, but also clean-cut lines, each of which perimetrically delimiting a respective elongated portion having a longitudinal axis. Alternatively, the or each cutting member can be configured to obtain a cut web or sheet made of paper material provided with a plurality of clean-cut lines, each of which perimetrically delimiting a respective elongated portion having a longitudinal axis.

Advantageously, each longitudinal axis of each curved elongated portion can be parallel to the predetermined feeding direction.

In particular, between the folding device and the cutting device an advancing device can be provided arranged to cause the web or sheet made of paper material to advance along a predetermined advancing direction parallel or orthogonal to the predetermined feeding direction.

According to an embodiment of the invention, the folding device can be positioned downstream of the cutting device. In particular, the folding device can be configured to fold the web or sheet made of paper material to cause the plurality of curved elongated portions to be detached at the aforementioned cutting lines, such as weakening lines, or tear-off lines, or clean-cut lines.

According to an alternative embodiment of the invention, the folding device can be positioned upstream of the cutting device. In particular, the folding device can be configured to fold the web or sheet made of paper material along a plurality of folding lines, in such a way to fold the web or sheet made of paper material in a plurality of portions or strips of sheets. More in particular, the cutting device can be configured to cut each portion or strip of sheet, in such a way to make on the same at least one respective weakening line perimetrically delimiting a respective curved elongated portion.

Advantageously, the aforementioned curved elongated portions can have a substantially “U-shaped” transversal cross section.

In particular, the aforementioned folding device can comprise a first and a second counter-rotating folding rolls arranged to rotate about a respective rotation axis orthogonal to the feeding direction. More in particular, the aforementioned first and second folding rolls can be respectively provided with a plurality of protruding portions and a plurality of recessed portions alternating with each other.

Preferably, the plurality of protruding portions and the plurality of recessed portions can have shapes complementary to each other and can be configured to penetrate to each other at the aforementioned folding zone in such a way to apply the aforementioned folding action on the web or sheet made of paper material.

According to a possible embodiment of the invention, the plurality of protruding portions and the plurality of recessed portions can be oriented longitudinally to the first and second folding rolls.

In particular, the plurality of protruding portions and the plurality of recessed portions longitudinally oriented to the first and second folding rolls can be oriented parallel to the predetermined advancing direction, if the folding device is positioned downstream of the cutting device.

In an alternative embodiment of the invention, the plurality of protruding portions and the plurality of recessed portions longitudinally oriented to the first and second folding rolls can be oriented orthogonally to the predetermined feeding direction, if the folding device is positioned upstream of the cutting device.

In particular, the or each cutting member can be positioned on a first and a second counter-rotating folding rolls arranged to rotate about a respective rotation axis. More in particular, the first and second counter-rotating folding rolls can be arranged to fold the web or sheet made of paper material to cause the web or sheet made of paper material same to be cut by the or each cutting member. In this way, with a single device it is possible to make the aforementioned cutting lines and to detach the curved elongated elements at the cutting lines.

According to another aspect of the invention, a method for producing drink stirring sticks made of paper comprises the steps of:
feeding a web or sheet made of paper material along a predetermined feeding direction;
whose main characteristic is that a separation step is, furthermore, provided for separating a plurality of curved elongated portions from said web or sheet made of paper material;
   that said separation step comprises the steps of:
folding the web or sheet made of paper material;
cutting said web or sheet made of paper material in order to make a plurality of cutting lines, each of which perimetrically delimiting a respective elongated portion having a longitudinal axis;
   and that said folding step is carried out by:
a first folding member provided with at least one protruding portion;
a second folding member provided with at least one recessed portion having a shape complementary to said, or each, protruding portion of said first folding member, said or each protruding portion and said, or each recessed portion being arranged to be positioned adjacent to respective sides of said web or sheet made of paper material, to apply a folding action on said web or sheet made of paper material at a folding zone.

### BRIEF DESCRIPTION OF THE DRAWINGS

The invention will be now illustrated with the following description of an exemplary embodiment thereof, exemplifying but not limitative, with reference to the attached drawings wherein:

FIG. 1 diagrammatically shows a side elevational perspective view of a first embodiment of a machine, according to the invention, for producing drink stirring sticks;

FIG. 2A diagrammatically shows an enlargement of a portion of FIG. 1 to highlight some technical characteristics of a possible embodiment of the stirring sticks made of paper material that can be obtained by the machine according to the invention;

FIG. 2B diagrammatically shows a transversal cross section of a stirring stick made of paper material that can be obtained by the machine according to the invention;

FIG. 3 diagrammatically shows a side elevational perspective view of a first alternative embodiment of the machine of FIG. 1 for producing drink stirring sticks;

FIG. 4A diagrammatically shows an enlargement of a portion of FIG. 3 to highlight some technical characteristics of a first embodiment of the elongated portions that can be obtained by the cutting device provided by the invention;

FIG. 4B diagrammatically shows an enlargement of an alternative embodiment of the elongated portions of FIG. 4A to highlight some technical characteristics;

FIG. 5 diagrammatically shows an enlargement of the folding device provided in the machine of FIG. 3 to highlight some technical characteristics;

FIG. 6 diagrammatically shows the machine of FIG. 3 in a plan view;

FIG. 7 diagrammatically shows an enlargement of the production waste obtained downstream of the folding device of the machine of FIG. 6 to highlight some technical characteristics;

FIG. 8 diagrammatically shows a cross section of the machine of FIG. 6 according to the arrows VIII-VIII;

FIG. 9 diagrammatically shows a side elevational perspective view of another alternative embodiment according to the invention of the machine of FIG. 1;

FIG. 10 diagrammatically shows an enlargement of the worked web or sheet made of paper material that is obtained downstream of the folding device of the machine of FIG. 9 to highlight some technical characteristics;

FIG. 11 diagrammatically shows a plan view of the machine of FIG. 9;

FIG. 12 diagrammatically shows a section according to the arrows XII-XII of the machine of FIG. 11;

FIG. 13 diagrammatically shows an enlargement of the machine of FIG. 12 to highlight some technical characteristics;

FIG. 14 diagrammatically shows a side elevational perspective view of another alternative embodiment of the machine of FIG. 1;

FIG. 15A diagrammatically shows a side elevational perspective view of still another alternative embodiment of the machine of FIG. 1;

FIG. 15B shows an enlargement of a part of the machine of FIG. 15A to highlight some technical characteristics;

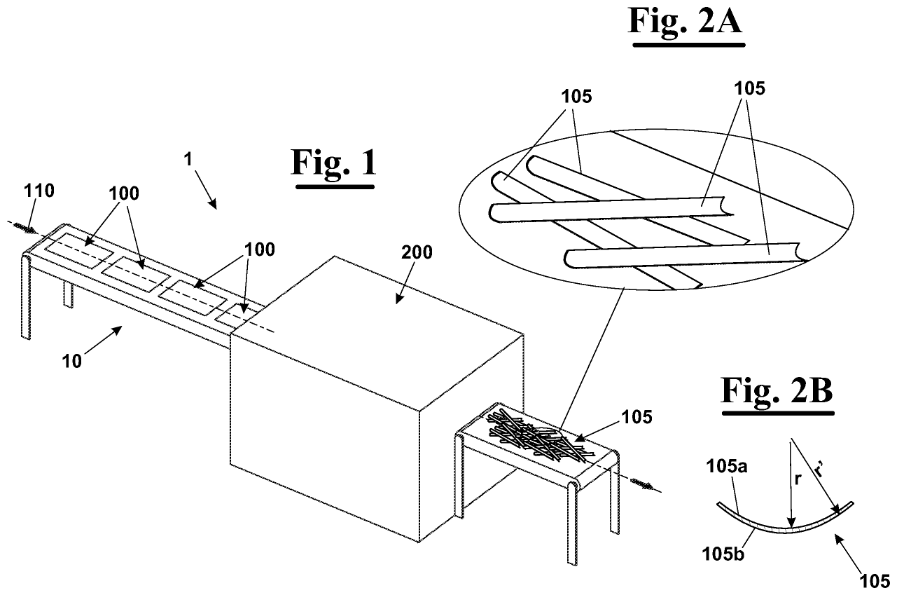

the FIGS. 16A and 16B diagrammatically show a side elevational perspective view of further alternative embodiments of the machine of FIG. 1.

### DETAILED DESCRIPTION OF SOME EXEMPLARY EMBODIMENTS OF THE INVENTION

As diagrammatically shown in FIG. 1, a machine 1, according to the invention, for producing sticks 105 made of paper material, in particular sticks for drinks such as coffee, tea, milk, cappuccino and similar, for example disposed by a vending machine of drinks comprises a feeding device 10, for example a belt conveyor, or a roller conveyor, configured to feed a web or a plurality of sheets made of paper material 100 along a predetermined feeding direction 110. In particular, the paper material can be cardboard, or thin card.

Advantageously, the machine 1 comprises, furthermore, a separation unit 200 positioned, at least partly, along the aforementioned predetermined feeding direction 110. In particular, the separation unit 200 can be configured to fold the web or sheet made of paper material 100 in such a way to separate a plurality of curved elongated portions 105, i.e. the sticks, from the worked web or sheet made of paper material 100. More in particular, the aforementioned curved elongated portions 105 can have a substantially “U-shaped” transversal cross section, or however can be shaped in such a way to have a predetermined radius of curvature r (FIGS. 2A and 2B), preferably for all their length, or substantially for all their length. In particular, as diagrammatically shown in FIG. 2B, the curved elongated portions 105 will have two surfaces 105a and 105b opposite to each other, having, respectively, a first and a second radius of curvature r and r′. These can be equal, or substantially equal, depending on the producer need, or the type of paper material that is used for producing them. The particular characteristic of the sticks 105 that are produced by the machine 1, according to the invention, to have a determined curvature allows, in particular, to obtain a product with a high moment of inertia and, therefore, unlike the flat sticks of prior art, able to support the stresses to which they are subject without deforming during their use to stir, for example, a drink, such as coffee, tea, cappuccino, milk, etc. stresses which increase if the drink is a hot drink. In particular, the ratio between length and width of the curved elongated portions 105 can be comprised between 10 and 50, advantageously between 20and 40.

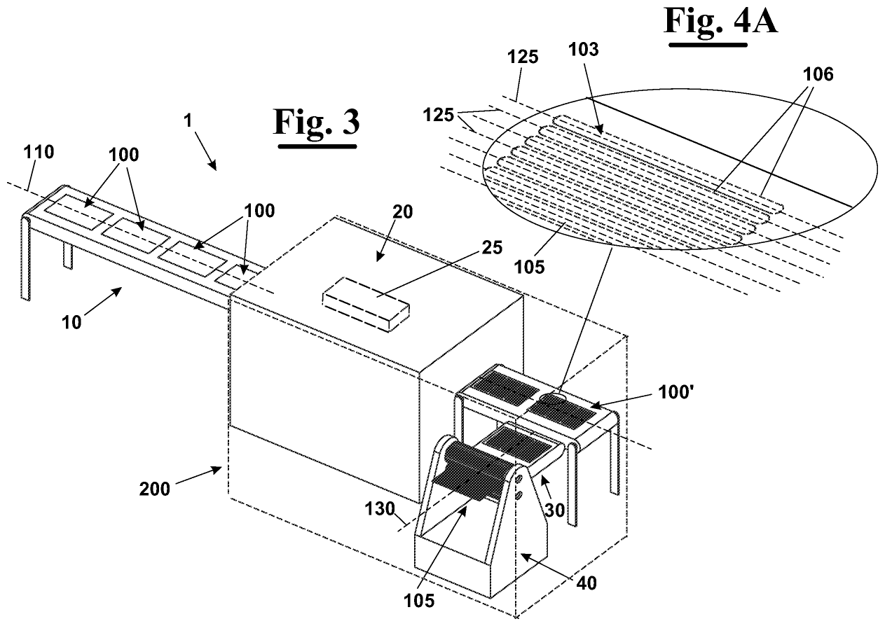

As diagrammatically shown in the embodiment of FIG. 3, the separation unit 200 can comprise a folding device 40 configured to fold the web or sheet made of paper material 100, in such a way to separate the aforementioned plurality of curved elongated portions 105 from the folded web or sheet made of paper material.

Advantageously, the folding device 40 can be equipped with a first folding member 41, for example a first folding roll, provided with at least one protruding portion 43 and a second folding member 42, for example a second folding roll, provided with at least one recessed portion 44. In particular, the or each protruding portion 43, and the or each recessed portion 44 have shapes that are complementary to each other. More in particular, the or each protruding portion 43, and the or each recessed portion 44 can be arranged to be positioned adjacent to the respective sides 101 and 102 of the web or sheet made of paper material 100 to apply a folding action on the same at a folding zone 45.

According to a possible embodiment of the invention, the separation unit 200 can, furthermore, comprise a cutting device 20 provided with at least one cutting member 25, diagrammatically indicated in FIG. 3 with a block, that is configured to cut the web or sheet made of paper material 100 in such a way to obtain a cut web or sheet made of paper material 100′. For example, the cutting member 25 can be a die cutting member, in particular a flat die cutting member, or a rotary die cutting member.

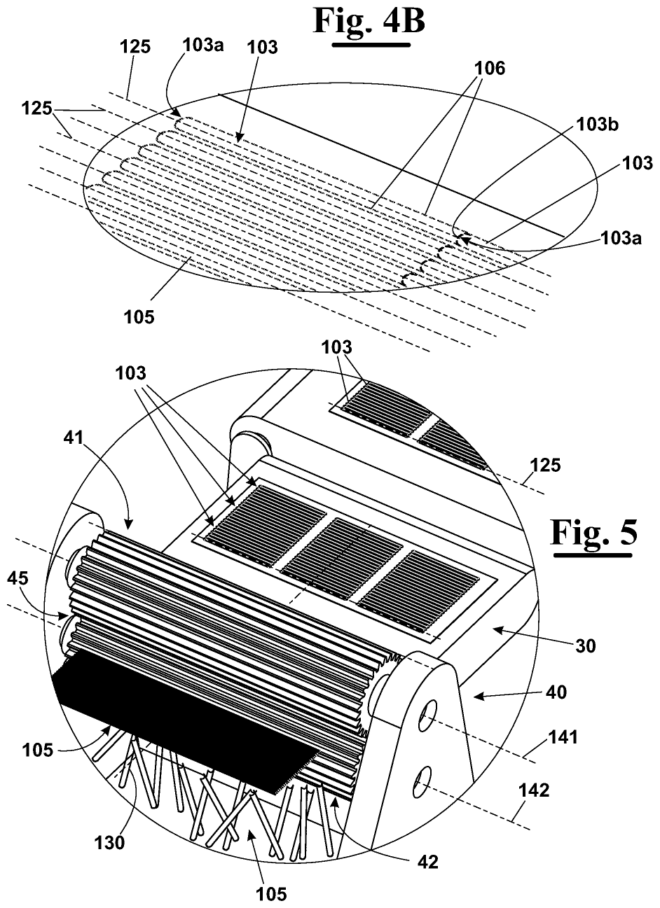

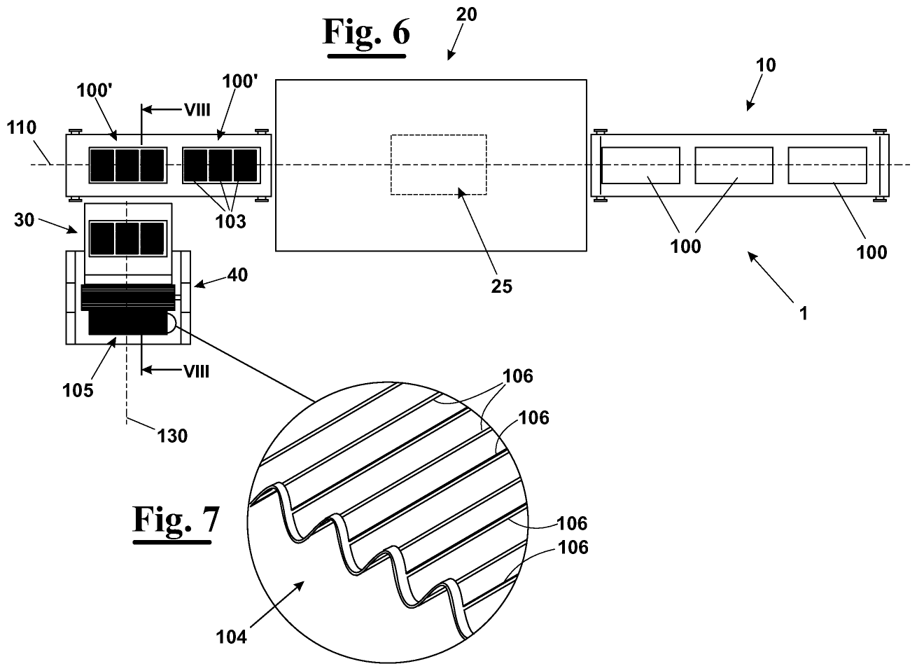

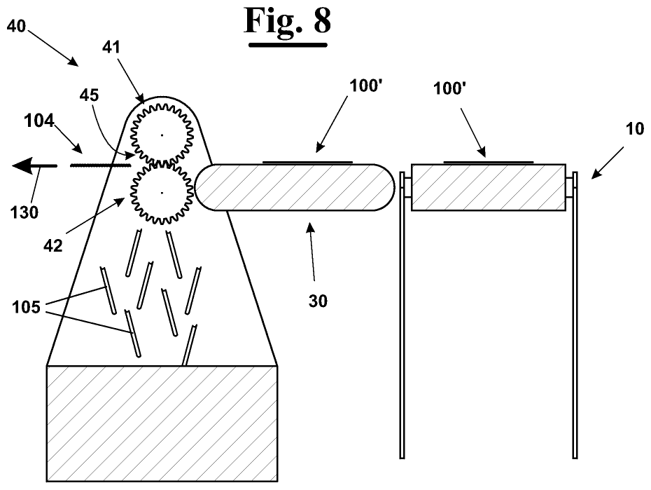

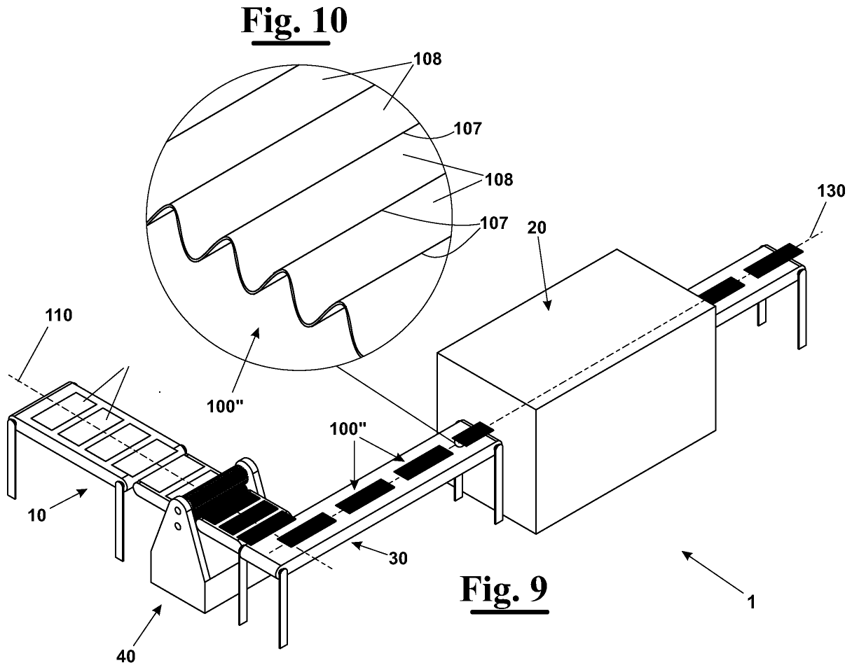

More in particular, as diagrammatically shown in FIG. 4, the cutting member 25 can be configured to make a plurality of weakening lines 106, or clean-cut lines, each of which perimetrically delimiting a respective elongated portion 103, on the aforementioned web or sheet made of paper material 100. In particular, the weakening lines 106 can be of the type provided with a “tab-bond” of predetermined length which is, then, broken during the folding of the web or sheet made of paper material 100.

In particular, depending on the type of cutting device 20 that is used, it is possible to obtain a determined shape of the elongated portions 103 and, therefore, of the curved elongated portions 105 that are obtained at the end of the folding step.

In particular, in a first example, which is diagrammatically shown in FIG. 4A, the elongated portions 103 have a protruding edge at a longitudinal end 103a, and a recessed edge at the opposite longitudinal end 103b.

As diagrammatically shown in the alternative embodiment of FIG. 4B, instead, the elongated portions 103 can have protruding edges at both the longitudinal ends 103a and 103bopposite to each other. This embodiment allows, in particular, to significantly reduce the quantity of waste material, or scrap, which is obtained at the end of the production process. More in particular, as diagrammatically shown in FIG. 4B, the elongated portions 103 positioned along the same longitudinal axis 125 can have a common edge and, therefore, differently from the embodiment of FIG. 4A, between the elongated portion 103 positioned upstream, and the one positioned downstream no portion of web or sheet made of paper material stays unused.

Preferably, the cutting device 20 can be configured to make the elongated portions 103 in such a way that the same have the longitudinal axis 125 parallel, or substantially parallel, to the direction along which are moved, in particular to the feeding direction 110 (see for example FIG. 3).

In the embodiment that is shown as example in FIG. 5, the folding device 40 comprises a first and a second counter-rotating folding roll 41 and 42 arranged to rotate about a respective rotation axis 141 and 142. Advantageously, the rotation axes 141 and 142 of rolls 41 and 42 can be orthogonal to the predetermined feeding direction 110. The first and second folding rolls 41 and 42 are, preferably, provided, respectively, with a plurality of protruding portions 43 and a plurality of recessed portions 44 alternating with each other, having shapes complementary to each other, and arranged to penetrate to each other at the folding zone 45, in such a way to apply the aforementioned folding action on the web or sheet made of paper material 100. In particular, the rotation of the folding rollers 41 and 42 combined with the action applied by their protruding portions 43 and recessed portions 44, caused the elongated portions 103 to be curved, and the curved elongated portions 105 to be separated from the web or sheet made of paper material 100 at the cutting lines, such as weakening lines 106, or tear-off lines, or clean-cut lines. Another advantage of the present invention is to reduce the waste product 104 (diagrammatically shown in FIG. 7) constituted by the portions of web or sheet made of paper material remaining at the end of the separation step carried out by the folding device 40, or anyway by the separation unit 200.

In a possible embodiment, between the folding device 40 and the cutting device 20 can be provided an advancing device 30, for example a belt conveyor, or a roller conveyor, arranged to cause the cut or folded web or sheet made of paper material 100′, 100″, depending on that the folding device 40 is respectively positioned downstream, or upstream, of the cutting device 20, along a predetermined advancing direction 130. This can be parallel or orthogonal to the aforementioned predetermined feeding direction 110. In particular, in case that the advancing direction 130 is orthogonal to the feeding direction 110, a push member can be provided, which is not shown in the figures for reasons of clarity. For example, the push member can be provided with a back and forth motion along a direction orthogonal to the feeding direction 110 and to be configured to cause the worked web or sheet 100′, or 100″, made of paper material, to move from a first to a second conveyor. Alternatively to the case described above, the movement of the cut or folded web or sheet made of paper material 100′, 100″, from the feeding direction 110 to the advancing direction 130 can be obtained by a curved linking portion, which is not shown for simplicity.

In a further alternative embodiment, the movement of the cut web or sheet made of paper material 100′, or folded 100″, from the feeding direction 110 to the advancing direction 130 can be carried out by a transfer device, in particular provided with catching members arranged to catch, for example from the above, the cut or folded web or sheet made of paper material 100′, 100″ from the upstream conveyor, which causes the movement along the feeding direction 110, rotating the same by 90° and releasing the same on the downstream conveyor, which causes its movement along the advancing direction 130. For example, the transfer device can be a carousel device arranged to take a cut or folded sheet or web 100′, 100″ at a time, from the upstream conveyor and after having rotated the same about an axis orthogonal both to the feeding direction 110 and to the advancing direction 130, to discharge the rotated sheet or web on the downstream conveyor.

In particular, as diagrammatically shown in FIG. 3, the folding device 40 can be positioned downstream of the cutting device 20. In this case, the folding device 40 can be configured to fold the web or sheet 100′ made of paper material on which the cutting device 20 had made the aforementioned elongated portions 103 to cause the plurality of elongated and curved portions 105, i.e. the sticks, to be detached at the aforementioned cutting lines, in particular weakening lines 106 (see FIG. 5).

In the alternative embodiment of the invention that is diagrammatically shown in the FIGS. from 9 to 13, the aforementioned folding device 40 can be positioned upstream of the cutting device 20. In this case, the folding device 40 can be configured to fold the web or sheet 100 made of paper material along a plurality of folding lines 107, in such a way to fold the web or sheet 100 same in a plurality of portions or strips of sheets, 108 in such a way to obtain a web or sheet made of paper material 100″ (see FIG. 10). In this case, the cutting device 20 can be configured to cut each portion or strip of sheet 108 in such a way to make at least one respective weakening line 106 which perimetrically delimits a respective curved elongated portion 105.

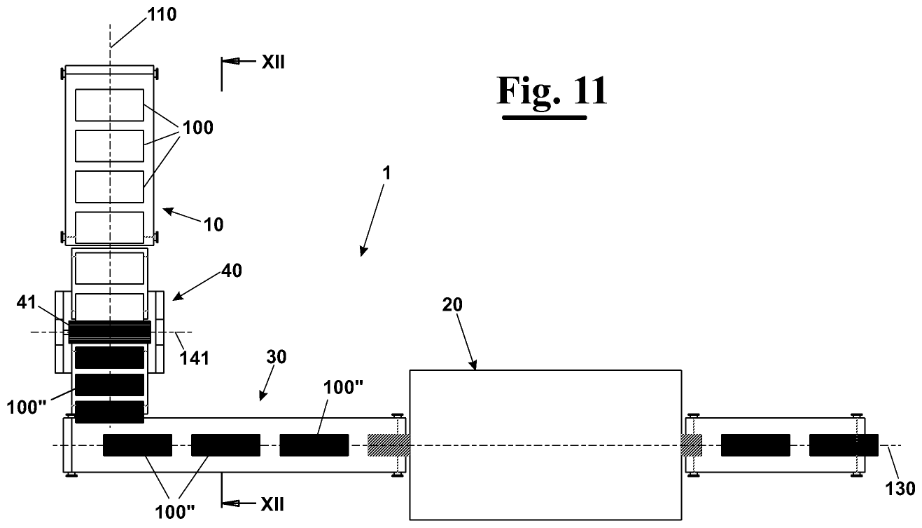

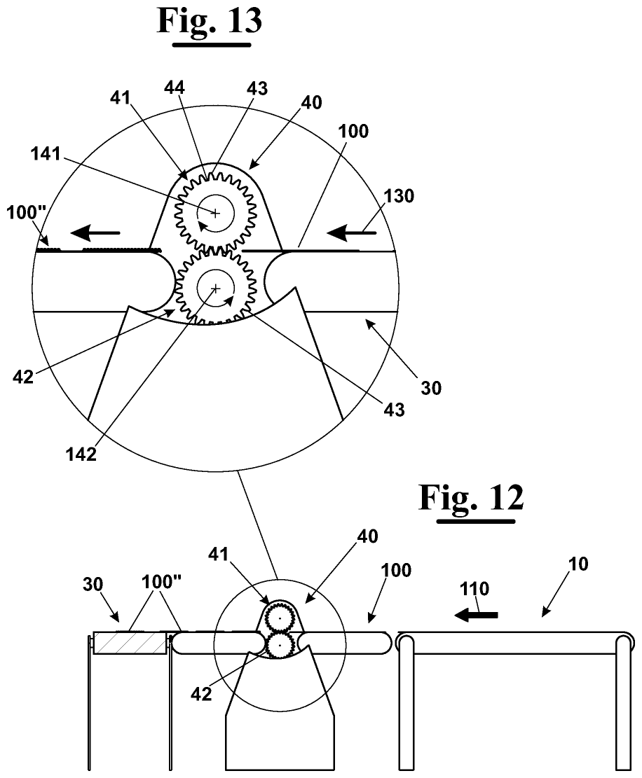

As diagrammatically shown, for example, in the FIGS. 3, 5, 7 and 11, the plurality of protruding portions 43 and the plurality of recessed portions 44 can be oriented longitudinally to the first and second folding rolls 41 and 42. More in particular, the plurality of protruding portions 43 and the plurality of recessed portions 44 longitudinal to the first and second folding rolls 41 and 42 can be oriented parallel to the predetermined advancing direction 110, if the folding device 40 is positioned downstream of the cutting device 20.

In the alternative embodiment that is diagrammatically shown in the FIGS. from 9 to 13, in which the folding device 40 is, instead, positioned upstream of the cutting device 20, as described above, the plurality of protruding portions 43 and the plurality of recessed portions 44 which are longitudinal to the first and second folding rolls 41 and 42 can be, instead, oriented orthogonally to the predetermined feeding direction 110.

In the embodiments of the invention that are described above with reference to the FIGS. from 1 to 13, both in the embodiment of the invention which provides that the folding device 40 is positioned downstream of the cutting device 20, and in the alternative embodiment which, instead, provides that the folding device 40 is positioned upstream of the cutting device 20, the protruding portions 43 and the recessed portions 44 are oriented longitudinally to the folding rollers 41 and 42. However, it is also foreseen the possibility that the or each protruding portion 43, and the or each recessed portion 44 can be arranged circumferentially to the folding rollers 41 and 42.

In an embodiment provided, but not shown for simplicity, the or each cutting member 25, in particular a blade, advantageously a die cutting member, can be positioned on at least one between the first and second counter-rotating folding rolls 41 and 42. In this case, the first and second counter-rotating folding rolls 41 and 42 are arranged to fold the web or sheet made of paper material 100, analogously to what is described above with reference to FIG. 5, and, during rotation, the or each cutting member 25 cuts the web or sheet made of paper material 100 same. In particular, the cutting lines 106 made by the or each cutting member 25 on web or sheet made of paper material 100, can be weakening lines 106, in particular provided with a “tab-bond” of predetermined length, or “clean-cut” lines 106. More in particular, the first and second counter-rotating folding rolls 41 and 42, during rotation about the respective rotation 141 axes and 142 cause, practically contemporaneously, the web or sheet made of paper material to be cut by the or each cutting member 25, and the curved elongated elements 105 to be detached.

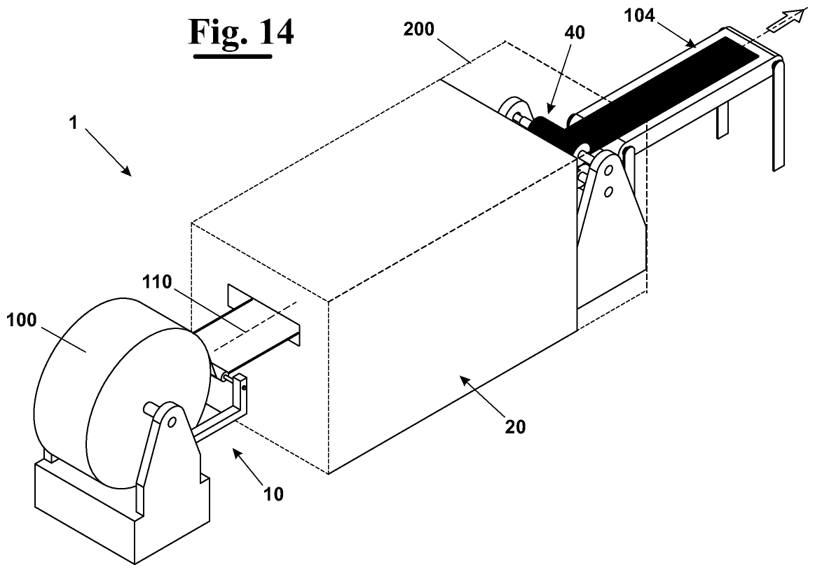

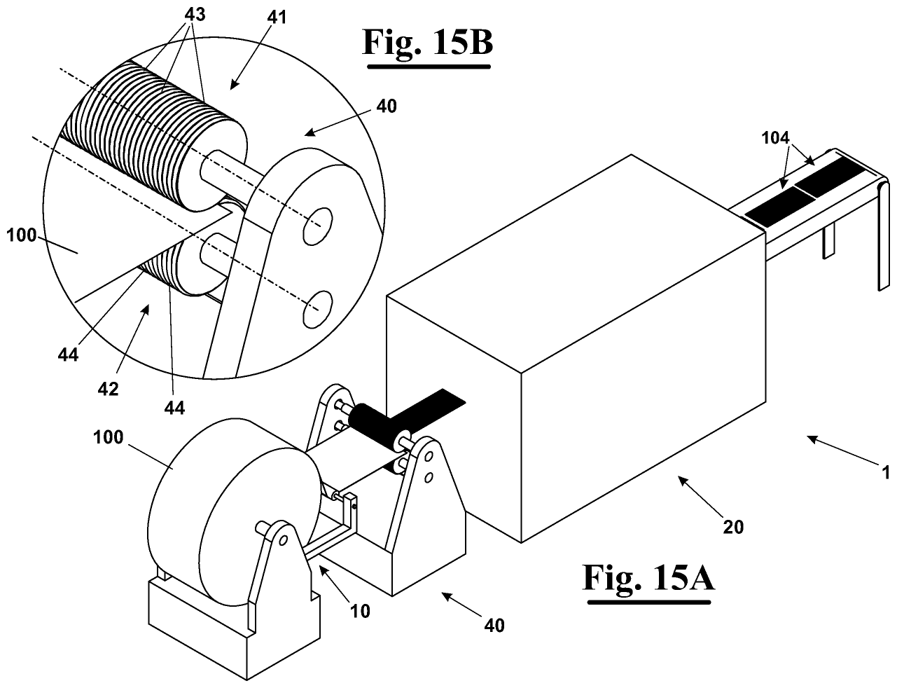

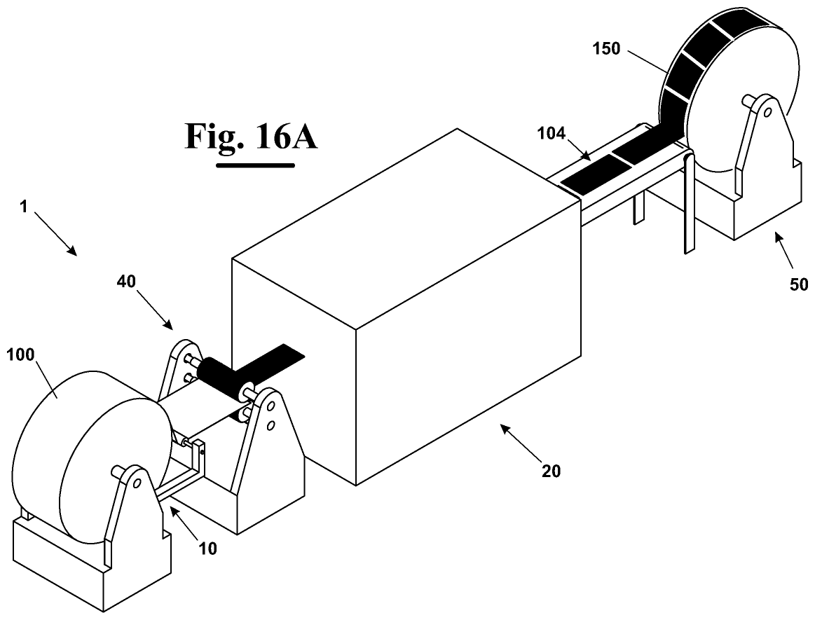

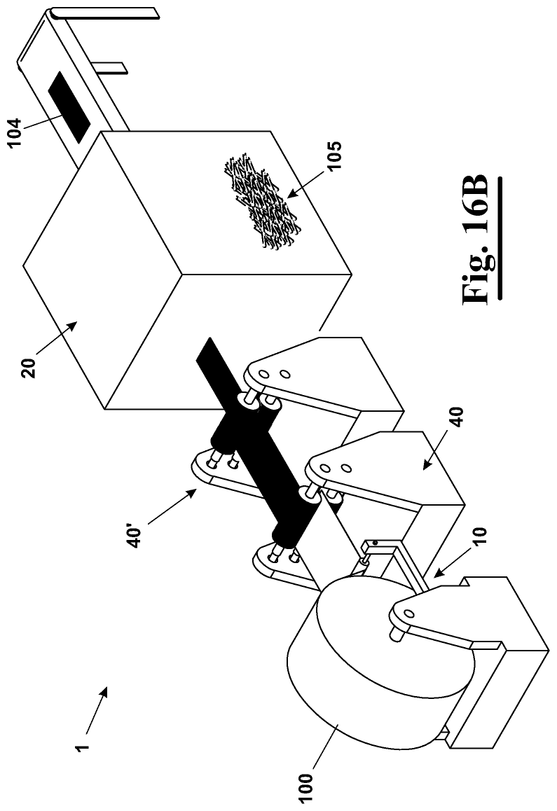

In the FIGS. 14 and 15, the embodiments of the invention are diagrammatically shown that provide to produce the drink stirring sticks 105 starting from a web made of paper material, in particular cardboard, or thin card. As diagrammatically shown in the FIGS. 14 and 15, in this case, the web made of paper material 100 is, advantageously, unwound from a roll made of paper material. For example, the roll made of paper material can be mounted on an unwinding device 10 arranged to support the same and to cause the roll to be unwound as well as the feeding of the same along the aforementioned feeding direction 110.

In the embodiment that is diagrammatically shown in FIG. 14, the separation unit 200 provides the positioning of the cutting device 20 upstream of the folding device 40. In particular, downstream of the folding device the production 40, scrap 104 is diagrammatically shown, that is the residual part obtained from the separation of the sticks 105 from the web made of paper material 100 produced by the folding action analogously to what has been described above for the case in cui the machine 1 is arranged to work a sheet, or more precisely a plurality of sheets 100 subsequent to each other. In particular, below the folding device 40, in the case that the separation is carried out by the folding device 40, or below the cutting device 20, if the separation of the sticks 105 from the waste product is carried out at the cutting device 20, a container body can be provided, that is not shown in the figures for simplicity, into which the sticks 105 can fall by gravity once that they are separated from the web or sheet made of paper material 100.

In the alternative embodiment of FIG. 15A, the separation unit 200 provides, instead, the positioning of the cutting device 20 downstream of the folding device 40. In this case, analogously to what is described above with reference to the FIGS. from 9 to 13, the folding device 40 is arranged to make a series of folding lines 107 on the web made of paper material 100 that is worked, thus, obtaining a folded web 100″. This is, then, worked by the cutting device 20, for example provided with a die cutting member, to make the cutting lines 106, and precisely the weakening lines, or clean-cut lines, on the portions or strips of the folded sheet or web 100″ and, then, to obtain the sticks 105.

As diagrammatically shown in the enlargement of FIG. 15B, the folding device 40, in particular when it is positioned upstream of the cutting device 20, can comprise a first and a second counter-rotating folding roll 41 and 42 arranged to rotate about a respective rotation axis 141 and 142, but, with respect to the embodiment that is described above, in particular with reference to FIG. 5, provides a first roll, for example the roll 41 provided with circumferential protrusions, preferably having a curved contour, and a second roll, for example the roll 42, provided with circumferential recesses, or grooves, preferably with a curved contour, complimentary to the aforementioned protrusions.

In the further alternative embodiment, which is diagrammatically shown in FIG. 16A, downstream of the last device, for example the cutting device 20, a winding device 50 can be provided, for example a rewinder, configured to wind the scrapes 104 forming a corresponding log, or roll, of production waste 150. In this way, it is possible to reduce the encumbrance of the waste material produced at the end of the process and to simplify the removal operations of the same from machine 1, for example to be sent to a recycling line, which is not shown in the figures, and, then, to be afterwards reintroduced, in case, along the production line, in particular to be fed again to the machine 1 for a new production cycle.

In another embodiment of the invention that is diagrammatically shown in FIG. 16B, a first and a second folding device 40 and 40′ can be provided positioned one downstream of the other and configured to gradually fold the web or sheet made of paper material 100. This technical solution, in particular, allows to simplify the folding steps for folding the webs or sheets 100 made of paper material having a high thickness, in particular higher than 2 mm and/or made of paper materials having a high paper weight.

The foregoing description of a specific embodiment will so fully reveal the invention according to the conceptual point of view, so that others, by applying current knowledge, will be able to modify and/or adapt for various applications such an embodiment without further research and without parting from the invention, and it is therefore to be understood that such adaptations and modifications will have to be considered as equivalent to the specific embodiment. The means and the materials to realise the different functions described herein could have a different nature without, for this reason, departing from the field of the invention. It is to be understood that the phraseology or terminology employed herein is for the purpose of description and not of limitation.

1. A machine for producing drink stirring sticks made of paper material comprising:
a feeding device configured to feed a web or sheet made of paper material along a predetermined feeding direction;
said machine being characterized in that it comprises a separation unit positioned along said predetermined feeding direction, said separation unit being configured to separate a plurality of curved elongated portions from said web or sheet made of paper material, in that said separation unit comprises at least one cutting member configured to cut said web or sheet made of paper material and to obtain a plurality of cutting lines, each of which perimetrically delimiting a respective elongated portion having a longitudinal axis; in that said separation unit comprises a folding device configured to fold said web or sheet made of paper material in such a way to separate said plurality of curved elongated portions from said web or sheet made of paper material and in that said folding device is equipped with:
a first folding member provided with at least one protruding portion;
a second folding member provided with at least one recessed portion having a shape complementary to said or each protruding portion of said first folding member, said or each protruding portion and said or each recessed portion being arranged to be positioned adjacent to respective sides of said web or sheet made of paper material, to apply a folding action on said web or sheet made of paper material at a folding zone.

2. Machine, according to claim 1, wherein said separation unit furthermore, comprises a cutting device provided with said or each cutting member configured to cut said web or sheet made of paper material in such a way to obtain a cut web or sheet made of paper material provided with said plurality of cutting lines, each of which perimetrically delimiting a respective elongated portion having a longitudinal axis.

3. Machine, according to claim 2, wherein between said folding device and said cutting device an advancing device is provided arranged to cause said web or sheet made of paper material to advance along a predetermined advancing direction parallel or orthogonal to said predetermined feeding direction.

4. Machine, according to claim 2, wherein said folding device is positioned downstream of said cutting device and is configured to fold said web or sheet made of paper material to cause said plurality of elongated portions to be detached at said cutting lines to obtain said plurality of curved elongated portions.

5. Machine, according to claim 2, wherein said folding device is positioned upstream of said cutting device and is configured to fold said web or sheet made of paper material along a plurality of folding lines in such a way to fold said web or sheet in a plurality of portions of sheet and wherein said cutting device is configured to cut each portion of sheet in such a way to make at least one respective weakening line perimetrically delimiting a respective elongated portion.

6. Machine, according to any of the previous claims, wherein said folding device comprises a first and a second folding roll counter-rotating with respect to each other arranged to rotate about respective rotation axes orthogonal to said predetermined feeding direction, said first and second counter-rotating folding rolls being, respectively, provided, with a plurality of protruding portions alternate ad a plurality of recessed portions having complementary shapes with respect to each other and arranged to penetrate each other at said folding zone in such a way to apply said folding action on said web or sheet made of paper material.

7. (canceled)

8. Machine, according to claim 6, wherein said plurality of protruding portions and said plurality of recessed portions are oriented longitudinally to said first and second counter-rotating folding rolls and wherein said plurality of protruding portions and said plurality of recessed portions are oriented parallel to said predetermined advancing direction, if said folding device is positioned downstream of said cutting device.

9. Machine, according to claim 7, wherein said plurality of protruding portions and said plurality of recessed portions longitudinal to said first and second counter-rotating folding rolls are oriented orthogonally to said predetermined feeding direction if said folding device is positioned upstream of said cutting device.

10. Machine, according to claim 1, wherein said, or each, cutting member is positioned on a first and a second counter-rotating folding roll arranged to rotate about a respective rotation axis, said first and second counter-rotating folding rolls being arranged to fold said web or sheet made of paper material to cause said, or each, cutting member to cut said web or sheet made of paper material, to make said cutting lines, and to detach said curved elongated members at said cutting lines.

11. Machine, according to claim 1, wherein said plurality of curved elongated portions have a substantially “U-shaped” transversal cross section.

12. Machine, according to claim 1, wherein said plurality of curved elongated portions have a transversal cross section with a predetermined radius of curvature (r) for all their length, or substantially for all their length.

13. (canceled)

14. Machine according to claim 1, wherein said plurality of curved elongated portions has a first and second surface opposite to each other having respective transversal cross section with a first and a second radius of curvature and wherein said first and second radii of curvature (r,r′) are equal, or substantially equal.

15. Machine, according to claim 1, wherein each curved elongated portion of said plurality has a predetermined length and a predetermined width, and wherein the ratio between said predetermined length and said predetermined width is set between 10 and 50.

16. Machine, according to any of the previous claims, wherein said cutting member is a die cutting member.

17. Machine, according to any of the previous claims, wherein said cutting member is configured in such a way to make on said web or sheet made of paper material said elongated portions having a first and a second protruding edge at the opposite longitudinal ends.

18. Machine, according to any of the previous claims, wherein said cutting member is configured in such a way to make on said web or sheet made of paper material said elongated portions having a protruding edge at a longitudinal end and a recessed edge at the opposite longitudinal end.

19. Machine, according to claim 3, wherein a transfer device is, furthermore, provided configured to transfer said web or sheet made of paper material from said feeding direction to said advancing direction.

20. Machine, according to claim 1, wherein said web made of paper material is arranged to be unwound from a roll of paper material mounted on an unwinding device arranged to support said roll of paper and to cause the same to be unwound and fed along said feeding direction.

21. Machine, according to claim 1, wherein a winding device is, furthermore, provided configured to wind scrapes obtained during the working of said web or sheet made of paper material forming a corresponding roll of production waste.

22. Machine, according to claim 1, wherein said, or each, cutting member is arranged to make on said sheet or web, a plurality of cutting lines selected from the group comprising:
weakening lines provided with a tab-bond of predetermined length;
pre-cut lines;
tear-off lines;
clean-cut lines.

23. (canceled)
